(19) United States
(12) Patent Application Publication
(10) Pub. No.: US 2007/0281853 A1
(43) Pub. Date: Dec. 6, 2007

(54) Manufacturing method of fuel cell with integration of catalytic layer and micro sensors

(76) Inventors: Chi-Yuan Lee, Jhonghe City (TW); Shuo-Jen Lee, Yonghe City (TW); Chi-Wei Chung, Madou Township (TW); Chi-Lei Hsieh, Banciao City (TW); Guan-Wei Wu, Su-ao Township (TW); Yu-Ming Lee, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/806,533

(22) Filed: Jun. 1, 2007

(30) Foreign Application Priority Data
Jun. 6, 2006 (TW) 095120022

(51) Int. Cl. H01M 4/88; B05D 5/12

(52) U.S. Cl. 502/101; 427/115

(57) ABSTRACT

This invention is to introduce a manufacturing method of fuel cell with integration of catalytic layer and micro sensors, which comprises following steps: manufacturing multi-hole silicon layer step, generating catalytic layer step, forming insulation layer step, integrating micro sensors step, and finalizing step. With the function of gas-diffusion layer in the multi-hole silicon wafer and multiple catalytic grains evenly spread over the inner walls of flow-way holes of the silicon wafer, a great catalytic layer can be formed effectively. Further, micro sensors properly are integrated. This invention's merits include simple structure and capabilities of simultaneously detecting temperature and humidity. Plus, it can heat up internally for a fuel cell.

### BACKGROUND OF INVENTION

1. Field of the Invention

This invention relates to a manufacturing method of fuel cell with integration of catalytic layer and micro sensors. Particularly, this invention relates to a manufacturing method of fuel cell to integrate micro temperature sensors, micro humidity sensors, gas-diffusion layer, catalytic layer, and flow field plates together. The structure is simple after integration. It can detect temperature and humidity simultaneously. And, it can also generate heats internally inside the fuel cell.

2. Description of the Prior Art

The temperature and humidity of the electrolyte membrane inside a fuel cell will influence the performance of a fuel cell. If the humidity is too high, too low, or the temperature is too high, it will cause the overall performance down. Thus, it is a very important issue to monitor the internal humidity and temperature of fuel cells.

Current structure design of fuel cells makes it difficult or impossible to integrate micro sensors, gas-diffusion layer, catalytic layer, and flow field plates (or called bi-polar plates) together. Thus, it causes significant hassles no matter in manufacturing, measuring, or calibrating. Besides, the manufacturing costs are high, and the fuel cell's volume is hard to be decreased.

Next, if micro sensors are disposed (or embedded) in the flow ways of fuel cells, it is very difficult to lay out their connecting lines (or wires). And, its original flow field will be disturbed without doubt. Moreover, due to the short circuit problem easily caused by high humidity, the micro sensors cannot precisely detect the condition in the wet flow ways. Furthermore, unless both the micro temperature sensors and micro humidity sensors are disposed inside the fuel cell, the temperature and humidity cannot be detect simultaneously.

Thus, a new manufacturing technique is needed to solve aforementioned problems.

### BRIEF SUMMARY OF THE INVENTION

The primary object of the invention is to provide a manufacturing method of fuel cell with integration of catalytic layer and micro sensors. Its structure is simple after integration.

The next object of the invention is to provide a manufacturing method of fuel cell with integration of catalytic layer and micro sensors. In which, it can detect temperature and humidity simultaneously.

Another object of the invention is to provide a manufacturing method of fuel cell with integration of catalytic layer and micro sensors. It not only can detect temperature but also can heat up the fuel cell internally.

In order to achieve the above-mentioned object, a technical solution is provided. A manufacturing method of fuel cell with integration of catalytic layer and micro sensors comprises following steps:

[a] manufacturing multi-hole silicon layer step: preparing a plain, no-hole silicon wafer that has two main surfaces: a first surface and a second surface; a designated etching solution being employed on the first surface to make multiple flow ways and then further by photolithographic techniques, making a plurality associated holes on the second surface, forming a multi-hole silicon layer functional as gas-diffusion layer;

[b] generating catalytic layer step: preparing multiple catalytic grains, and then spreading them evenly on inner walls of the associated holes of the multi-hole silicon layer, enabling it work as a catalytic layer;

[c] forming insulation layer step: an insulation layer being formed on the second surface;

[d] integrating micro sensors step: attaching a micro sensor layer, which comprises at least one micro temperature or humidity sensor, on the insulation layer; and

[e] finalizing step: making a fuel cell with integrations of micro sensor layer, gas-diffusion layer, catalytic layer, and flow field plates.

### BRIEF DESCRIPTION OF THE DRAWINGS

FIG. 1 shows the manufacturing flow chart of the invention.

FIG. 2 is a partially enlarged perspective view of the multi-hole silicon layer.

FIG. 3 is a partial sectional view of FIG. 2.

FIG. 4 shows the first half manufacturing processing processes of the invention.

FIG. 5 shows the second half manufacturing processing processes of the invention.

FIG. 6 is a partial sectional view of the finished product.

FIG. 7 is a view illustrating the micro temperature sensor.

FIG. 8 is a view illustrating the micro humidity sensor.

FIG. 9 illustrates a structure with the micro sensors separated horizontally.

FIG. 10 illustrates another structure with micro sensors separated vertically.

### DETAILED DESCRIPTION OF THE INVENTION

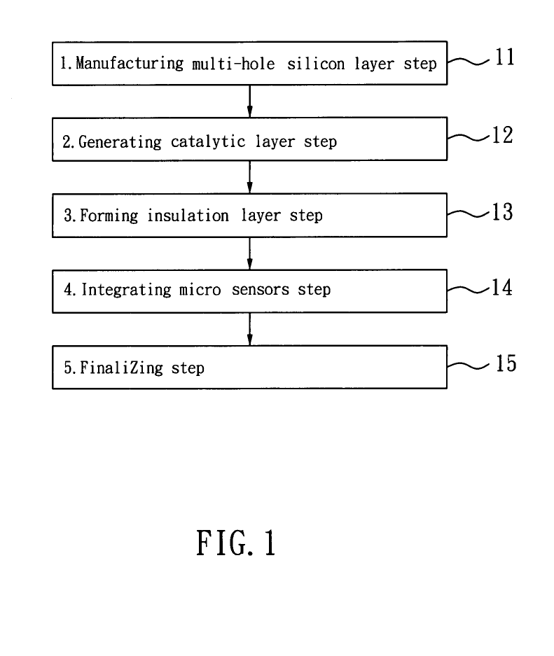

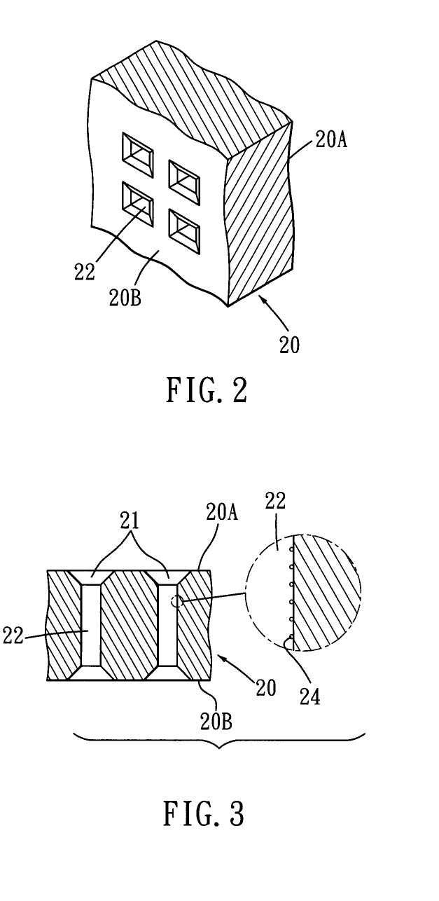

First, referring to the FIGS. 1, 2 and 3, this invention is a manufacturing method of fuel cell with integration of catalytic layer and micro sensors. It comprises the following steps:

1. Manufacturing multi-hole silicon layer step 11;

2. Generating catalytic layer step 12;

3. Forming insulation layer step 13;

4. Integrating micro sensors step 14; and

5. Finalizing step 15.

About the details of all these steps mentioned above, they are described as follows:

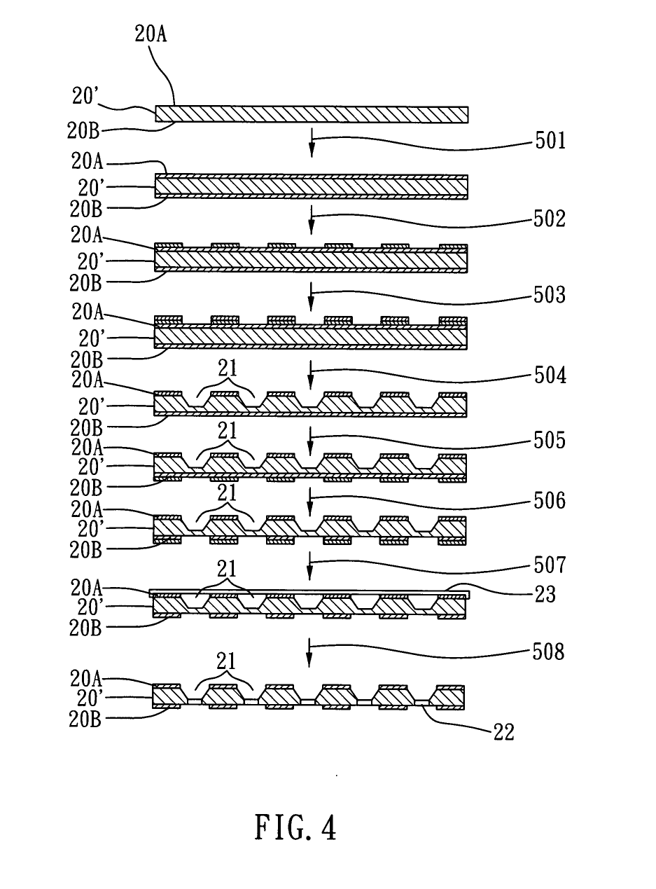

In the Step 1 of “Manufacturing multi-hole silicon layer step 11”: First, prepare a plain, no-hole silicon wafer (as shown in FIG. 4) that has two main surfaces: a first surface 20A and a second surface 20B. A designated etching solution is employed on the first surface 20A to make multiple flow ways 21 and then further, by photolithographic techniques, to make their associated holes 22 on the second surface 20B, forming a multi-hole silicon layer 20. The flow ways 21 are connected to their associated holes 22 to enable it functional as gas-diffusion layer.

In real practice of Step 1 “Manufacturing multi-hole silicon layer step 11”, first prepare an n-type silicon wafer 20′, and then undergo the following detailed processes as shown in FIG. 4.

The 1st Process 501: Employ a high-temperature furnace to oxidize and grow a approximately 1000 Å thick Si₃N₄ layer on both sides (first surface 20A and second surface 20B) of the silicon wafer 20′. The Si₃N₄ layer will be used as the etching mask when etching with KOH in later stage.

The 2nd Process 502: Define rectangular shapes on the first surface 20A with photolithographic techniques.

The 3rd Process 503: Conduct “reactive ion etching” on first surface 20A with gold as the HF etching mask to prevent defined rectangular shapes from being damaged by etching solution of HF, and speed up etching with back-lighting method.

The 4th Process 504: Utilize an etching solution of KOH to etch predetermined widths and depths of the flow ways 21 on the first surface 20A of silicon wafer 20′, and preserve certain proper thickness as the thickness of gas-diffusion layer.

The 5th Process 505: On the second surface 20B of silicon wafer 20′, conduct a photolithographic process to define the pattern and size of the holes 22.

The 6th Process 506: Conduct “reactive ion etching” on the second surface 20B.

The 7th Process 507: Again, employ an etching blocking mask 23 to protect the first surface 20A, and then etch out multi-hole silicon layer 20 with etching solution of HF so as to form the gas-diffusion layer.

The 8th Process 508: Remove the etching blocking mask 23.

Concerning the Step 2 “Generating catalytic layer step 12”, first prepare multiple catalytic grains (or particles) 24 (EX: the designated metal grains as shown in FIG. 3), and then spread them evenly on the inner wall of the holes 22 of the multi-hole silicon layer 20, enabling it also work as a catalytic layer.

In real practice, this step is to employ chemical method to transform the inner walls of holes 22 of the multi-hole silicon layer 20 into positive-charged functional groups, enabling it to attract negative-charged Pt precursor (PtCl₆²⁻) by static electricity, then embed nano Pt grains or particles (catalytic grains 24) onto the inner walls of holes 22 through ion exchange method, and finally undergo hydrogen reduction processing to not only increase quantity of Pt grains but also make them evenly spread inside the holes 22. Comparing to the electro-deposition and physical vapor deposition (PVD) methods that just can deposit catalysts on the surface of the holes 22, the employment of nano grains can enhance the functionality and life of the fuel cell due to better durability and resistance of the catalysts. Therefore, nano Pt grains 24 is used here as the catalyst in the process.

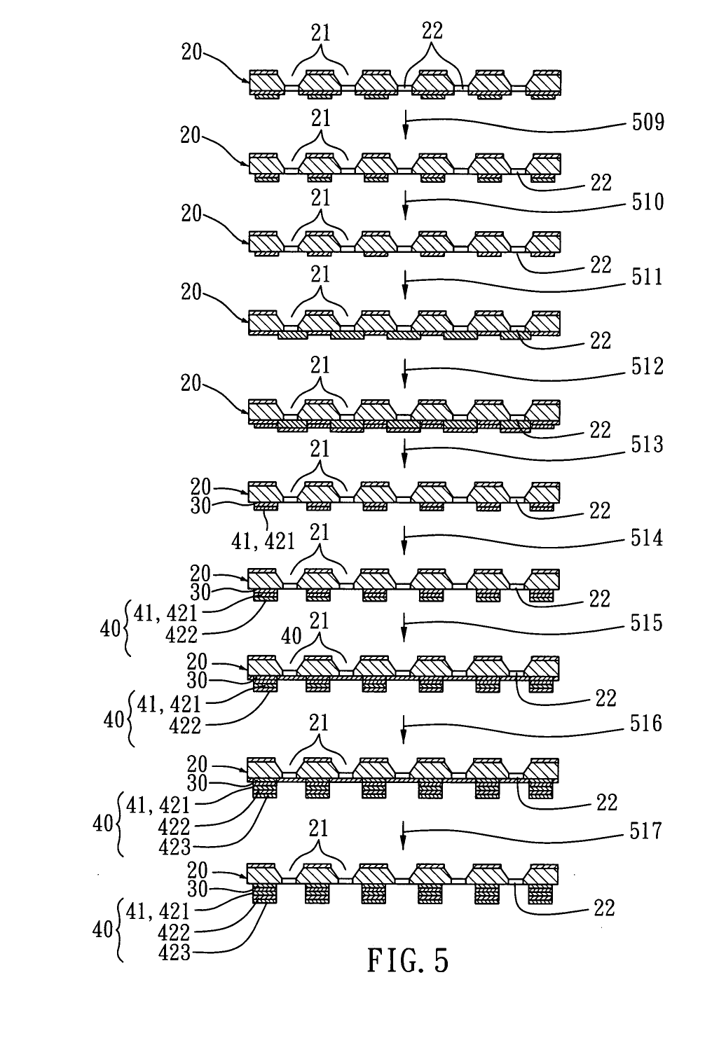

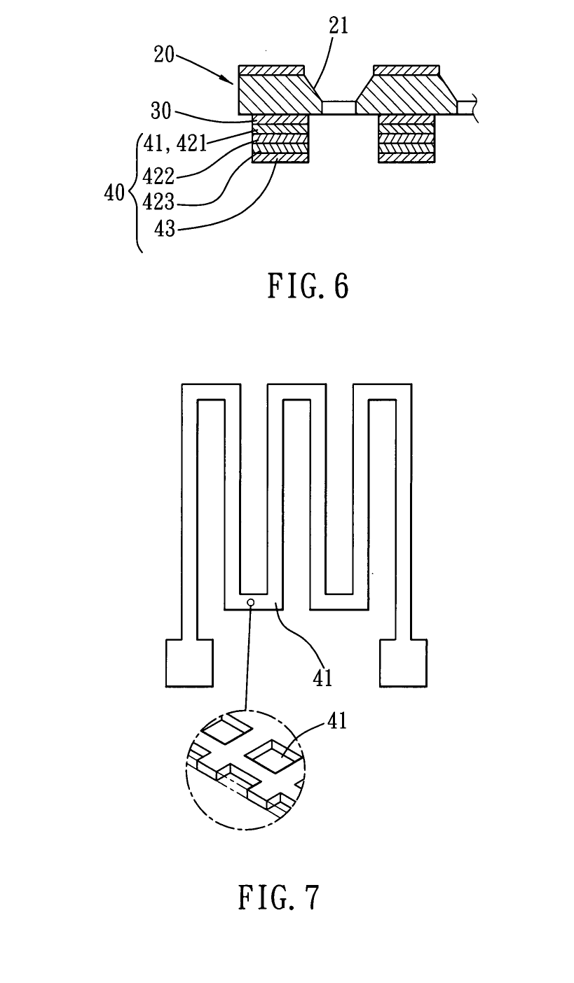

In the Step 3 “Forming insulation layer step 13”, an insulation layer will be formed on the second surface 20B. Please refer to the embodiment as shown in FIGS. 5 and 6, which comprises the following processes:

The 9th Process 509: Define insulation areas needed for the temperature and humidity 25 sensors by photolithographic processing including photoresist coating, exposure, and developing processing.

The 10th Process 510: Then conduct dry etch on the defined insulation areas by a reactive ion etching machine.

The 11th Process 511: Again, employ another photolithographic processing including photoresist coding, exposure, and developing processing to define other areas than the ones for the electrodes of the temperature and humidity sensors.

With regard to the Step 4 “Integrating micro sensors step 14”, at least one micro sensor layer 40 will be facilitated upon the insulation layer 30, and it has at least one function selecting from temperature detecting and humidity detecting.

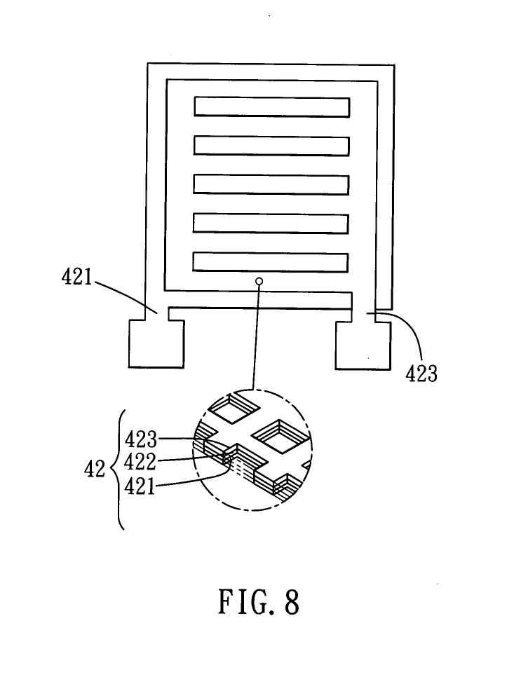

With references to FIGS. 5, 6, 7 and 8, an embodiment with integration of both temperature and humidity sensors are further described as follows.

The 12th Process 512: Coat or deposit a film of Ti and Pt with an e-beam evaporator.

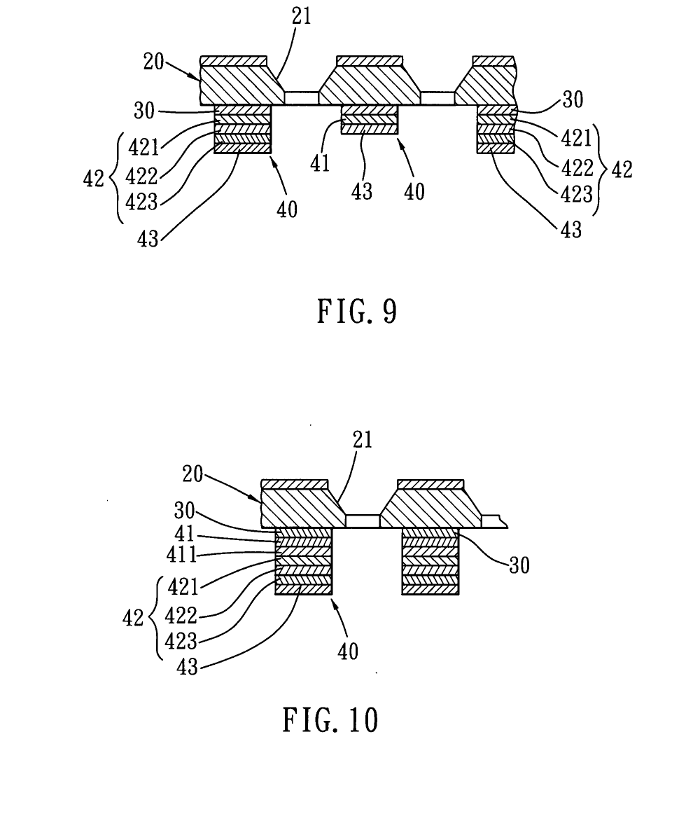

The 13th Process 513: Conduct a lift-off processing to make patterns of electrodes for micro temperature and/or humidity sensors. This is to generate the temperature sensor 41 and the lower electrode 421 of the humidity sensor 42. Although it is shown in the figure that the temperature sensor 41 and the lower electrode 421 share the same layer (or even the same one), the layout can be also modified as the following patterns.

[a] They are separated horizontally as shown in FIG. 9. That is, they are set in designated locations of same layer, but do not touch each other; or,

[b] They are separated vertically as shown in FIG. 10. There is a separating layer 411 between the temperature sensor 41 and the lower electrode 421 of the humidity sensor 42. It might be made by a conventional coating or depositing technique.

Therefore, aforementioned methods should be all protected under the scope of the patent claims.

The 14th Process 514: Coat the detecting membrane 422, which is either Benzocyclobutene (BCB) or polyimide, of the humidity sensor 42.

The 15th Process 515: Coat a gold layer by vapor-deposition method via a thermal evaporator.

The 16th Process 516: Again, employ photolithographic processing including photoresist coating (to form an outer photoresist layer 43), exposure, and developing processing to accomplish an upper electrode 423 of the humidity sensor 42 and necessary conducting lines of the temperature and humidity sensors 41, 42.

The 17th Process 517: Then further, etch with etching solution of gold.

In the Step 5 “Finalizing step 15”, this step is to finalize and make a fuel cell with integrations of micro sensor layer 40, gas-diffusion layer (multi-hole silicon layer 20), catalytic layer (the multiple catalytic grains 24 evenly spread inside the holes 22), and flow field plates.

Of course, finally a wire bonder can be employed to connect micro temperature and humidity sensors 41, 42 with the PCB board by aluminum lines (not shown in the Fig.), So, it can conduct the temperature and/or humidity detection later. Aforementioned is detailed description of this invention.

The aforementioned temperature sensor 41 means the detecting areas made by thermal resistant materials, which can be the curvy shape as shown in FIG. 7. Such shape is simpler and can contain a longer metal membrane in a small area. It mainly has two functions:

[1] Detecting temperature: Detect the resistance between the both ends of the temperature sensor 41, and find out its corresponding temperature value.

[2] Internal heating: Apply certain voltage between both ends of the temperature sensor 41 to make it generate heats. Thus, the applied voltage can be utilized to force the temperature increasing inside the fuel cell.

On the other hand, the micro humidity sensor 42 means the detecting areas made by polymeric materials, which generally adopts the sandwich structure (namely capacitor structure). That is, the internal humidity can be found out by detecting the capacity between the upper electrode 423 and lower electrode 421. Although the manufacturing process is more complicated, the sensitivity can be enhanced because the upper electrode 423 and lower electrode 421 have different locations and have larger contact areas.

Regarding to the detection of capacity, the capacity is proportional to the lapping area of the upper electrode 423 and lower electrode 421, and is inversely proportional to the thickness of the micro humidity sensor 42. In order to increase the capacity, either the thickness of the micro humidity sensor 42 needs to be decreased or the lapping area of the upper electrode 423 and lower electrode 421 needs to be increased. Thus, in the consideration of design of the micro humidity sensor 42, not only the geometric dimension (EX. Increase the size of the area) needs to be changed, but also the area size of the two electrodes should be considered to prevent occurrence of low capacity and performance of the fuel cell.

Of course, both temperature sensor 41 and humidity sensor 42 can be adjusted or modified in terms of quantity and measuring range/location. For example, temperature sensor 41 and humidity sensor 42 can be respectively set at the five locations: inlet and outlet of the flow way, one-quarter spot of the total length, two-quarter spot of the total length, and three-quarter spot of the total length. Or it can be designed based actual needs.

With all aforementioned, the merits of the invention can be summarized as follows:

[1] The structure is simple after integration. The invention integrates temperature and humidity sensors, gas-diffusion layer, catalytic layer, and flow field plates that are all needed for fuel cell, making its structure simpler.

[2] It can detect both temperature and humidity simultaneously. The invention introduces insulation layer to the fuel cell, and it attaches micro sensor layer for temperature and humidity sensors, making it capable of conveniently detecting both temperature and humidity of the fuel cell.

[3] Other than detecting temperature and humidity, it can also generate heats internally. The electrical resistance that makes the temperature sensors not only can be used for detecting the temperature, but also for heating up fuel cell internally when the certain voltage is applied on both sides of the temperature sensor. Thus, it can precisely control the fuel cell at a best operational temperature.

With all aforementioned, the invention deserves grant of a patent based on its capability of industrial application and absolute novelty. The example illustrated above is just an exemplary embodiment for the invention, and shall not be utilized to confine the scope of the patent. Any equivalent modifications within the scope of claims of the patent shall be covered in the protection for this patent.

What is claimed is:

1. A manufacturing method of fuel cell with integration of catalytic layer and micro sensors comprises following steps:
a. manufacturing multi-hole silicon layer step: preparing a plain, no-hole silicon wafer that has two main surfaces: a first surface and a second surface; a designated etching solution being employed on said first surface to make multiple flow ways and then further by photolithographic techniques, making a plurality associated holes on said second surface, forming a multi-hole silicon layer functional as gas-diffusion layer;
b. generating catalytic layer step: preparing multiple catalytic grains, and then spreading them evenly on inner walls of said associated holes of the multi-hole silicon layer, enabling it work as a catalytic layer;
c. forming insulation layer step: an insulation layer being formed on the second surface;
d. integrating micro sensors step: attaching a micro sensor layer, which comprises at least one micro temperature or humidity sensor, on said insulation layer; and
e. finalizing step: making a fuel cell with integrations of micro sensor layer, gas-diffusion layer, catalytic layer, and flow field plates.

2. The manufacturing method of fuel cell with integration of catalytic layer and micro sensors of claim 1, wherein the manufacturing multi-hole silicon layer step comprises:
1st Process: employing a high-temperature furnace to oxidize and growing a approximately 1000 Å thick Si₃N₄ layer on both said first and second surface;
2nd Process: defining rectangular shapes on first surface with photolithographic techniques;
3rd Process: conducting reactive ion etching on said first surface with gold as an HF etching mask to prevent defined rectangular shapes from being damaged by etching solution HF, and speeding up etching process with back-lighting method;
4th Process: utilizing an etching solution KOH to etch predetermined widths and depths of the flow ways on said first surface of silicon wafer, and preserving certain proper thickness as the thickness of gas-diffusion layer;
5th Process: on said second surface of silicon wafer, conducting a photolithographic process to define the shape and size of said associated holes;
6th Process: conducting reactive ion etching on said second surface;
7th Process: again, employing an etching blocking mask to protect the first surface, and then etch out multi-hole silicon layer with etching solution HF to form the gas-diffusion layer; and
8th Process: removing the etching blocking mask.

3. The manufacturing method of fuel cell with integration of catalytic layer and micro sensors of claim 1, wherein the forming insulation layer step comprises:
9th Process: defining insulation areas needed for the temperature and humidity sensors by photolithographic processing including photoresist coating, exposure, and developing processing;
10th Process: then conducting dry etch on the defined insulation areas by a reactive ion etching machine;
11th Process: again, employing another photolithographic processing including photoresist coating, exposure, and developing processing to define other areas than the ones for the electrodes of the temperature and humidity sensors;
12th Process: coating a film of Ti and Pt with an e-beam evaporator.
13th Process: conducting a lift-off processing to make patterns of electrodes for micro temperature and/or humidity sensors.

4. The manufacturing method of fuel cell with integration of catalytic layer and micro sensors of claim 1, wherein the integrating micro sensors step comprises:
14th Process: coating the Benzocyclobutene (BCB) as the detecting membrane of the humidity sensor;
15th Process: coating a gold layer by vapor-deposition with a temperature evaporator;
16th Process: again, employing photolithographic processing including photoresist coating to form an outer photoresist layer 43, exposure, and developing processing to accomplish an upper electrode of the humidity sensor and conducting lines of the temperature and humidity sensors;
17th Process: etching with etching solution of gold.

5. The manufacturing method of fuel cell with integration of catalytic layer and micro sensors of claim 1, wherein said micro temperature sensor is a thin film of Ti and Pt.

6. The manufacturing method of fuel cell with integration of catalytic layer and micro sensors of claim 1, wherein said micro humidity sensor is composed of a lower electrode, a humidity-detecting membrane, and a upper electrode.

7. The manufacturing method of fuel cell with integration of catalytic layer and micro sensors of claim 1, wherein said micro temperature and humidity sensors are separated horizontally.

8. The manufacturing method of fuel cell with integration of catalytic layer and micro sensors of claim 1, wherein said micro temperature and humidity sensors are separated vertically with a separating layer therebetween.
